(19) United States
(12) Patent Application Publication
(10) Pub. No.: US 2005/0012413 A1
(43) Pub. Date: Jan. 20, 2005

(54) Electric machine with improved contacting feature

(75) Inventors: Erich Bott, Hollstadt (DE); Reiner Seufert, Salz (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/856,346

(22) Filed: May 28, 2004

(30) Foreign Application Priority Data
May 30, 2003 (DE) 103 24 666.5

(51) Int. Cl. H02K 11/00; H02K 1/18

(52) U.S. Cl. 310/71; 29/596; 29/606; 310/218

(57) ABSTRACT

An electric machine includes a rotor and a stator, with at least the stator having salient poles and plural bobbins received by the poles. Each of the bobbins has a winding which is configured as toothed coil. Each bobbin includes a contact carrier for attachment of a winding starting end and a winding terminal end of the coil.

### CROSS-REFERENCES TO RELATED APPLICATIONS

This application claims the priority of German Patent Application, Serial No. 103 24 666.5, filed May 30, 2003, pursuant to 35 U.S.C. 119(a)-(d), the disclosure of which is incorporated herein by reference.

### BACKGROUND OF THE INVENTION

The present invention relates, in general, to the field of electric machines, and more particularly to an electric machine having improved contacting feature.

U.S. Pat. No. 4,633,114 describes an electric machine having a coil which is wound on a carrier. A retaining clip secures the pre-formed coil on the pole of a stator. U.S. Pat. No. 3,339,097 describes a coil bobbin which is positioned at a pole of an electric machine.

Electric machines having directly wound coils suffer shortcomings because of the difficulty to secure the winding ends since no space is available at the coil insulation. Loose winding ends are, however, unacceptable especially when automated switching is involved. Thus, winding ends must be interconnected by hand and/or connected to electric connecting lines. Then, the joints must be insulated and secured to the windings. This approach complicates the assembly and requires manual intervention so that the reproducibility of electric contacts is inadequate.

It would therefore be desirable and advantageous to provide an improved electric machine to obviate prior art shortcomings and to allow a simple contacting and simple coil wiring that can also be executed in an automated manner.

### SUMMARY OF THE INVENTION

According to one aspect of the present invention, an electric machine includes a rotor, and a stator, wherein at least the stator has salient poles and plural bobbins which are received by the poles, with each bobbin having a winding which is configured as toothed coil and including a contact carrier for attachment of a winding starting end and a winding terminal end of the coil.

The present invention resolves prior art problems by using a contact carrier for attachment of the winding ends. This ensures a reliable contact of the winding ends that allows a wiring of the coils also with other coils in a simple manner. Once the coil bobbin has been wound, the contact carrier is secured thereto. Of course, the contact carrier may also be already formed on the coil bobbin via a film hinge. In this case, the contact carrier is swung into the winding corridor of an automated winding device after a coil has been wound onto the bobbin.

According to another feature of the present invention, the contact carrier can be so constructed as to snap onto the bobbin. Suitably, the attachment of the carrier contact to the bobbin can be realized via locking hooks to ensure a secure attachment of the contact carrier to the coil bobbin.

According to another feature of the present invention, the contact carrier may have an attachment area for receiving the winding starting end, and an attachment area for receiving the winding terminal end. Further attachment areas may be provided for other components such as thermosensors. Advantageously, the contact carrier may be configured with contours to define the attachment areas. Examples of such contours include slots or wrapped-around domes. Suitably, the contact carrier is a formed part which may be made of plastic.

According to another aspect of the present invention, a method of making an electric machine includes the steps of forming a stack of stamped laminations having a plurality of poles, attaching wound coil bobbins onto the poles, mounting a contact carrier upon each of the coil bobbins, and securing insulation-displacement-contact connectors to the contact carrier for electric interconnection.

According to still another feature of the present invention, a method of making an electric machine includes the steps of holding a winding end of a coil on a coil bobbin in place by a freely moveable winding device, winding the coil onto the bobbin by the winding device, and holding the winding end of the coil, after the coil has been wound onto the bobbin, by a winding arm in such a manner as to allow access to a winding overhang.

In this way, it is possible to position one or more contact carriers onto the coil bobbin, e.g. by snapping the contact carrier onto the coil bobbin at least on an end side of the electric machine. Subsequently, the winding ends, winding starting end and winding terminal end, are guided through the winding device for attachment onto an attachment area on a contact carrier, and any projecting portion of the winding ends is clipped.

According to another feature of the present invention, the winding end may be secured to a contact element by resistance welding for attachment to the contact carrier. Of course, it is also possible to directly contact electrically by resistance welding two winding ends which are held at attachment areas of the contact carrier in adjacent relationship.

When connecting contacts to a mounting board, the contact carrier can be used to thermally insulate the mounting board form the coil. This mounting board allows wiring options of individual coils or coil groups in a simple manner as the contact areas are identical through use of the contact carriers, when electric machines of same type are involved.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective view of a star-shaped stator core;

FIG. 2 is a perspective view of a laminated yoke;

FIG. 3 is a perspective view of a coil bobbin with phase separator;

FIG. 4 is a perspective view of a coil bobbin without phase separator;

FIG. 5 is an exploded perspective view of a coil bobbin according to the present invention with contact carrier and connector;

FIG. 6 is a perspective view of the assembled coil bobbin; and

FIG. 7 is a side view of an assembled stator core of an electric machine, embodying the subject matter of the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

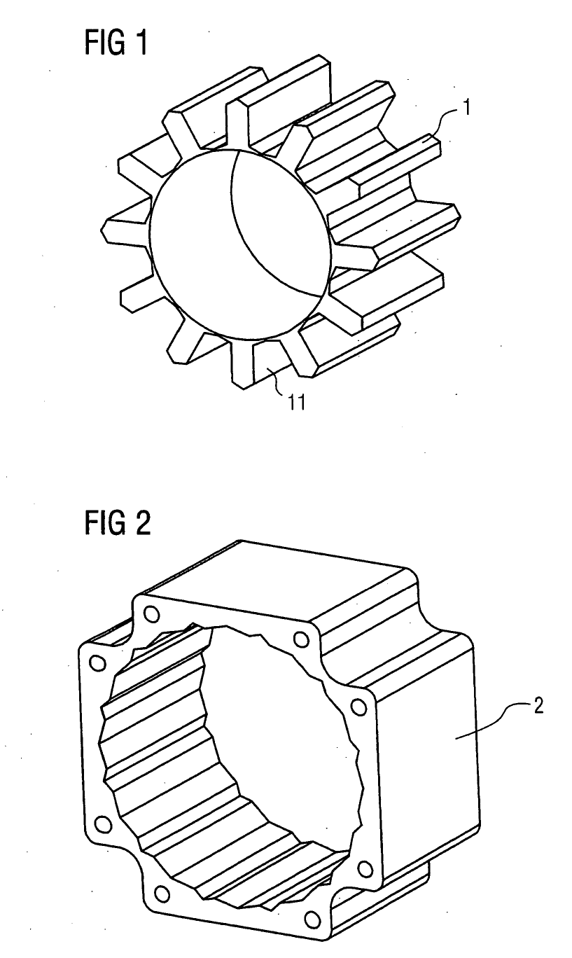

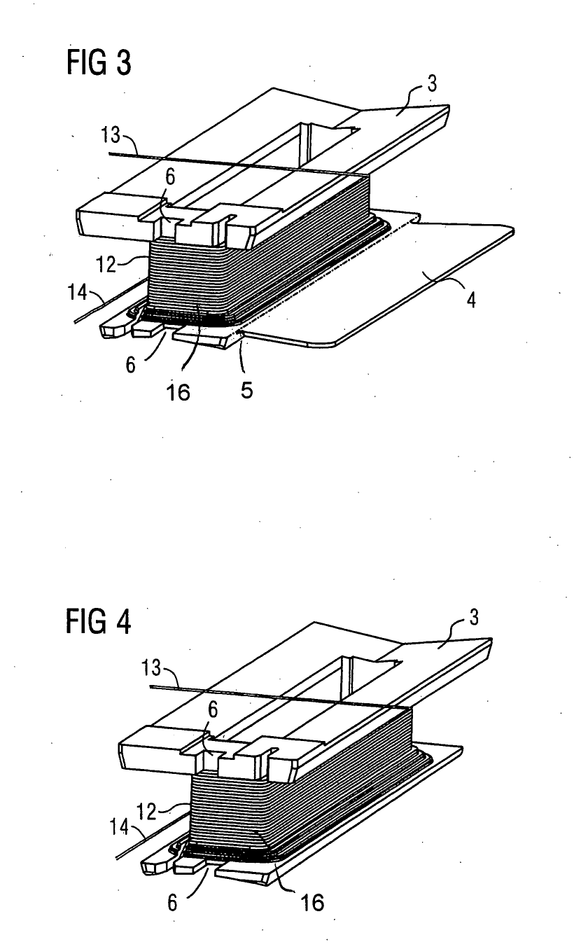

Turning now to the drawing, and in particular to FIG. 1, there is shown a perspective view of a star-shaped stator core 1 of an electric machine (not shown). The stator core 1 may hereby configured as laminated core structure or sintered core structure. The stator core 1 has circumferentially spaced, radially outwardly directed poles 11 of roof-shaped configuration for placement in a laminated yoke 2, as shown in FIG. 2. Of course, the illustration of the poles 11 is by way of example only, as other shapes are certainly conceivable for placement and securement in the yoke 2. Examples of possible configurations include rectangular shape or dovetail shape. Each pole 11 of the stator core 1 receives a coil bobbin 3 (FIG. 3) and a coil 12 which is wound onto a tubular body of the bobbin 3. Placement of the stator core 1 into the laminated yoke 2 can be realized by any one of conventional thermal and mechanical placement processes. Optionally, the bobbin 3 may also snap onto the assigned pole 11 through engagement in a respective groove (not shown).

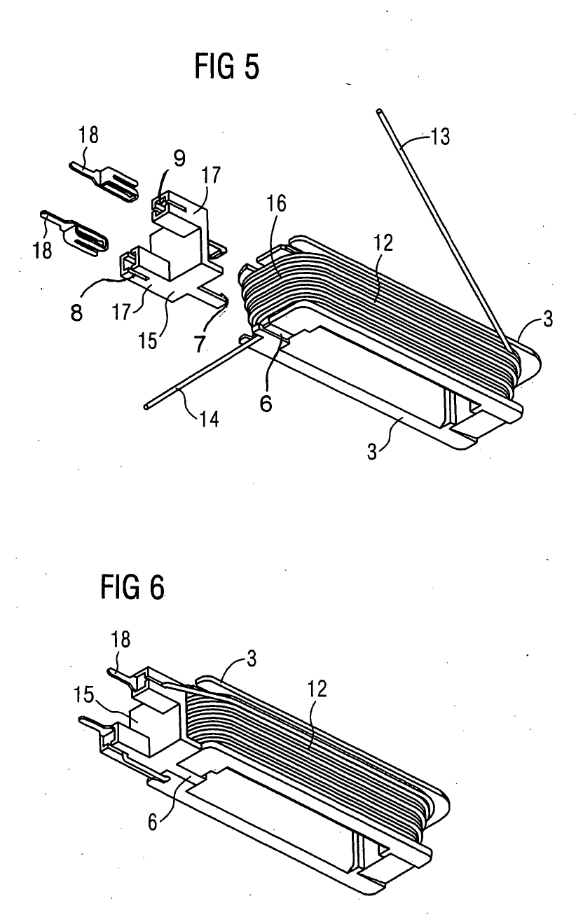

Referring now to FIG. 3, there is shown a perspective view of the coil bobbin 3 having an open film hinge 5 of a phase separator 4. In this state, the bobbin 3 can be provided with a winding, i.e. coil 12, by using any one of conventional automatic or semiautomatic winding devices. Hereby, the winding process is carried out by using a freely moveable winding device (not shown) which firmly holds one end of the coil 12, namely the winding starting end 14, and then wraps the winding about the bobbin 3. After establishing the coil 12, the other winding terminal end 13 is held by a winding arm of the winding device such that the winding overhang 16 is freely accessible at least on one end surface of the coil 12 in order to allow engagement of opposite locking hooks 7 of the contact carrier 15 in complementary grooves 6 on the topside and underside of the bobbin 3 for attachment of the contact carrier 15 onto the bobbin 3, as shown in FIG. 5. The winding ends 13, 14 are then routed through the winding device to attachment points 17 on the contact carrier 15. The attachment points 17 of the contact carrier 15 may be realized by shaped contours such as slots 8 or domes about which the winding ends 13, 14 are wound. Any portion of wire of the coil 12 that juts out beyond the attachment points 17 is clipped.

This type of securement of the winding ends 13, 14 allows an automatic circuiting, i.e. an electric connection of the coils 12 of the electric machine.

FIG. 4 shows the coil bobbin 3 without illustration of the phase separator 4.

Turning now to FIG. 5, there is shown an exploded perspective view of the coil bobbin 3 with contact carrier 15 and insulation displacement contact (IDC) connectors 18 which are received in a complementary receptacle 9 of the contact carrier 15 to establish a contact with the winding ends 13, 14 that have been attached to the contact carrier 15 at attachment points 17. Using welding, soldering, clamping, plugging, or crimping, the IDC connectors 18 can be connected to additional windings ends 13, 14 of neighboring or distant contact carriers 15 or to mounting units such as a mounting board or electric connecting lines.

The IDC connectors 18 also allow simultaneous contacting of several wires ends or winding ends 13, 14. Thus, incorporation of the IDC connectors 18 in the contact carrier 15 results in an electric connection between coils 12 and/or connecting lines.

A further option of establishing an electric contact can be realized by resistance welding, whereby the winding ends 13, 14 are electrically connected with a further contact element that is secured to the contact carrier 15. Likewise, two or more wires can directly electrically contact one another by resistance welding when held by the attachment points in side-by-side relationship.

FIG. 6 shows the assembled coil bobbin 3.

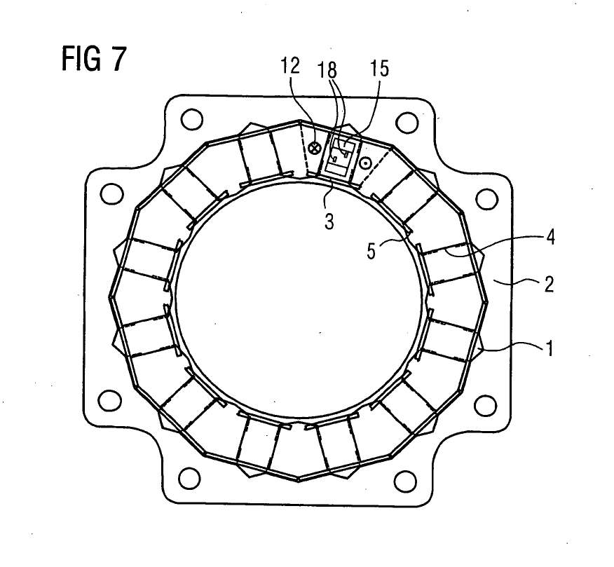

Referring now to FIG. 7, there is shown a side view of the assembled stator core 1 received in the laminated yoke 2. The contact carrier 15, including their IDC connectors 18, can now be electrically contacted in a simple manner to a mounting board which is attached at one end face and not shown in more detail. As a consequence, the contact carrier 15 provides at the same time a thermal insulation of the mounting board against the coil 12.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An electric machine, comprising a rotor, and a stator, wherein at least the stator has salient poles and plural bobbins which are received by the poles, with each of the bobbins including a winding which is configured as toothed coil and including a contact carrier for attachment of a winding starting end and a winding terminal end of the coil.

2. The electric machine of claim 1, wherein the contact carrier is constructed for securement to the bobbin.

3. The electric machine of claim 1, wherein the contact carrier snaps onto the bobbin.

4. The electric machine of claim 3, wherein the contact carrier has a locking hook for engaging a groove of the bobbin.

5. The electric machine of claim 1, wherein the contact carrier is formed onto the coil bobbin by a film hinge.

6. The electric machine of claim 1, wherein the contact carrier has an attachment area for receiving the winding starting end, and an attachment area for receiving the winding terminal end.

7. The electric machine of claim 6, wherein the contact carrier is configured with a contour to define the attachment areas.

8. The electric machine of claim 7, wherein the contour is a slot or a dome for wrapping the winding end around.

9. The electric machine of claim 1, wherein the contact carrier is a formed part made of plastic.

10. A method of making an electric machine, comprising the steps of:
forming a stack of stamped laminations having a plurality of poles;
attaching wound coil bobbins onto the poles;
mounting a contact carrier to each of the coil bobbins; and
securing insulation-displacement-contact connectors to the contact carrier for electric interconnection.

11. A method of making an electric machine, comprising the steps of:
holding a winding end of a coil on a coil bobbin in place by a freely moveable winding device;
winding the coil onto the bobbin by the winding device; and
holding the winding end of the coil, after the coil has been wound onto the bobbin, by a winding arm in such a manner as to allow access to a winding overhang.

12. The method of claim 11, further comprising the step of guiding the winding end through the winding device for attachment onto an attachment area on a contact carrier.

13. The method of claim 12, further comprising the step of clipping a projecting portion of the winding end.

14. The method of claim 12, wherein the winding end is secured to contact element by resistance welding for attachment to the contact carrier.

15. A bobbin for an electric machine, comprising:
a tubular base for attachment to a pole of a stator core of the electric machine a contact carrier;
a coil wound about the tubular base; and
a contact carrier constructed for connection to one end face of the tubular base and having an attachment point for receiving a winding end of the coil.

16. The bobbin of claim 15, further comprising an IDC connector received in a receptacle of the contact carrier for contacting the winding end.

17. The bobbin of claim 15, wherein the bobbin is formed with a groove, said contact carrier constructed to include a locking hook received by and engaging behind the groove for securing the contact carrier to the bobbin.

18. The bobbin of claim 17, wherein the bobbin has a topside and an underside, each of which formed with a said groove, said contact carrier including two of said locking hook in opposite relationship for respective engagement in the grooves of the bobbin.

19. The bobbin of claim 16, wherein the attachment point is a slot in the receptacle.
